(19) United States
(12) Patent Application Publication
(10) Pub. No.: US 2026/0260195 A1
(43) Pub. Date: Sep. 3, 2026

(54) METHODS FOR CREATING CONSTRUCTION TASK ORDERS

(71) Applicant: YIZHI TECHNOLOGY (CHENGDU) CO., LTD., Chengdu (CN)

(72) Inventors: Zhining GONG, Chengdu (CN); Yi ZHAO, Chengdu (CN); Lianrui YANG, Chengdu (CN)

(73) Assignee: YIZHI TECHNOLOGY (CHENGDU) CO., LTD., Chengdu (CN)

(21) Appl. No.: 19/654,535

(22) Filed: Apr. 22, 2026

Related U.S. Application Data
(63) Continuation-in-part of application No. PCT/CN2025/096992, filed on May 23, 2025.

(30) Foreign Application Priority Data
Jan. 15, 2025 (CN) 202510059124.5

(51) Int. Cl. G06Q 10/0631; G06F 3/04842; G06Q 50/08

(52) U.S. Cl. CPC G06Q 10/06316; G06F 3/04842; G06Q 50/08

(57) ABSTRACT

Disclosed is a method for creating a construction task order and a method for obtaining a task entry set. The method for creating a construction task order includes: in response to determining that a user performs a trigger operation on a preset control in a graphical user interface, reading candidate task entries from a task entry set, and displaying the candidate task entries in the graphical user interface; and in response to determining that the user performs a selection operation on the candidate task entries, writing a task combination corresponding to a selected candidate task entry into a construction task order to determine a construction task.

### CROSS-REFERENCE TO RELATED APPLICATIONS

This application is a Continuation-in-part of International Application No. PCT/CN2025/096992, filed on May 23, 2025, which claims priority to Chinese Patent Application No. 202510059124.5, filed on Jan. 15, 2025, the entire contents of each of which are hereby incorporated by reference.

### TECHNICAL FIELD

The present disclosure generally relates to the field of intelligent estimation technology, and in particular to a method for creating a construction task order.

### BACKGROUND

Currently, task management and assignment in engineering projects are often implemented by creating a task order. During a task order creation process, users from various units (e.g., general contractor, subcontractor, work team, etc.) need to expand a task tree, manually select task items level by level, and the task order creation can be completed only after leaf nodes are checked. Since the granularity of work packages differs among different units, i.e., the combinations of task items vary, manually checking task items one by one is prone to cause oversight, omission, and a waste of time. Furthermore, after creating a contract, users also need to manually create a task order to complete the dispatch, which presents the same issues mentioned above. Therefore, how to achieve rapid creation of a task order is a problem that urgently needs to be solved.

In view of this, embodiments of the present disclosure provide a method for creating a construction task order. The method enables a user to quickly determine a construction task based on system recommendations when creating a task order, and to quickly implement dispatch when managing a contract, thereby improving the efficiency of order creation and dispatch.

### SUMMARY

One or more embodiments of the present disclosure provide a method for creating a construction task order. The method is applied to a computing device having a graphical user interface and a memory. The method comprises: in response to determining that a user performs a trigger operation on a preset control in the graphical user interface, reading one or more candidate task entries from a task entry set pre-stored in the memory by a processor, and displaying the one or more candidate task entries in the graphical user interface; wherein each candidate task entry in the task entry set includes a task combination formed based on a plurality of construction task items, and the task entry set is pre-constructed by aggregating a plurality of pieces of historical task data and stored in the memory; and in response to determining that the user performs a selection operation on the one or more candidate task entries displayed in the graphical user interface, writing a task combination corresponding to a selected candidate task entry into a construction task order by the processor to determine a construction task

One or more embodiments of the present disclosure provide a method for obtaining a task entry set. The method comprises: generating a plurality of pieces of first entry data based on a plurality of pieces of historical task data, and dividing the plurality of pieces of first entry data into one or more first entry sets according to a first grouping characteristic; wherein the first grouping characteristic includes a unit type, and each piece of first entry data includes a historical task combination, cost data, and a frequency; for each first entry set: dividing a plurality of pieces of first entry data in the first entry set into a plurality of second groups according to a second grouping characteristic, and generating a plurality of pieces of second entry data based on the plurality of second groups, respectively; constructing a second entry set based on the plurality of pieces of second entry data from each first entry set; wherein the second grouping characteristic includes the historical task combination, a pricing manner, a measurement unit, and the cost data, and each piece of second entry data includes the historical task combination, a representative cost, and a representative frequency; and dividing a plurality of pieces of second entry data in the second entry set into a plurality of third groups according to a third grouping characteristic, and generating a plurality of construction task entries based on the plurality of third groups, respectively, to construct the task entry set; wherein the third grouping characteristic includes the historical task combination, and each construction task entry includes the historical task combination, a plurality of representative costs, and a representative frequency and a probability value corresponding to each representative cost respectively.

### BRIEF DESCRIPTION OF THE DRAWINGS

FIG. 1 is a schematic diagram illustrating an application scenario for a method for creating a construction task order according to some embodiments of the present disclosure;

FIG. 2 is a flowchart illustrating an exemplary process for creating a construction task order according to some embodiments of the present disclosure;

FIG. 3 is a flowchart illustrating an exemplary process for determining one or more candidate task entries according to some embodiments of the present disclosure;

FIG. 4 is a flowchart illustrating another exemplary process for determining one or more candidate task entries according to some other embodiments of the present disclosure;

FIG. 5 is a schematic diagram illustrating an exemplary process for obtaining a task entry set according to some embodiments of the present disclosure;

FIG. 6 is a flowchart illustrating an exemplary process for generating second entry data according to some embodiments of the present disclosure;

FIG. 7 is a flowchart illustrating an exemplary process for determining a preceding-subsequent task pair according to some embodiments of the present disclosure; and

FIG. 8 is a flowchart illustrating an exemplary process for determining an array set according to some embodiments of the present disclosure.

### DETAILED DESCRIPTION OF EMBODIMENTS

Accompanying drawings to be used in the description of embodiments will be briefly introduced below. The accompanying drawings do not represent all embodiments.

As used herein, “system”, “unit”, and/or “module” is a manner for distinguishing different components, elements, parts, portions, or assemblies of different levels. If other words can achieve the same purpose, then the words may be replaced by other expressions.

As shown in the present disclosure and the claims, unless the context clearly indicates otherwise, words such as “a”, “an”, and/or “the” are not specifically singular but may also include plural. Generally speaking, the terms “comprises” and “comprising” only suggest that the clearly identified steps and elements are included, and these steps and elements do not constitute an exclusive enumeration, and a manner or an apparatus may also include other steps or elements.

Flowcharts are used in the present disclosure to illustrate operations performed by a system according to embodiments of the present disclosure. It should be understood that preceding or subsequent operations are not necessarily performed precisely in order. Instead, the steps may be processed in reverse order or simultaneously. Meanwhile, other operations may also be added to the processes, or one or more steps may be removed from the processes.

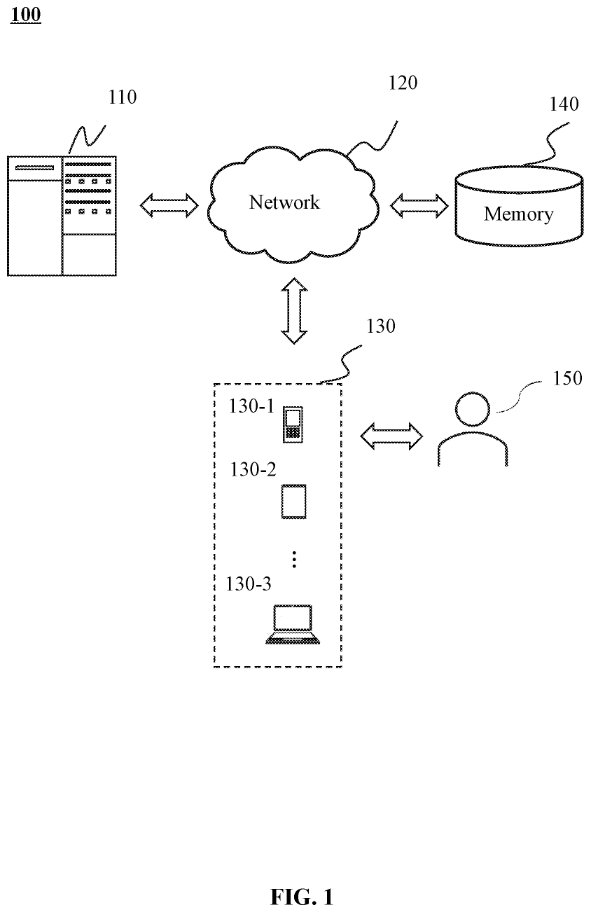

FIG. 1 is a schematic diagram illustrating an application scenario for a method for creating a construction task order according to some embodiments of the present disclosure. The method for creating a construction task order in the present disclosure may be applied to a plurality of scenarios where there is a demand for creating a construction task order, for example, when a user creates a construction task order, when a user dispatches orders after creating an engineering contract, or the like.

The construction task order refers to a document used for recording and circulating construction tasks, including various information related to the construction task, such as a construction area, a construction task item, a performance object, a construction period, disclosure content, and quantity and price information. By the method for creating a construction task order, the construction task in the construction task order may be determined. The construction task may include one or more construction task items, a pricing manner, and/or a measurement unit.

As shown in FIG. 1, an application scenario 100 may include a processor 110, a network 120, a terminal 130, a memory 140, and a user 150.

The processor 110 may process data and/or information obtained from the terminal 130, the memory 140, and the user 150. For example, in response to determining that a trigger operation is performed on a preset control, the processor 110 may display one or more candidate task entries on the terminal 130.

In some embodiments, the processor 110 may be a single server or a server group. In some embodiments, the processor 110 may be local or remote. The processor 110 may be directly connected to the terminal 130 and the memory 140 to access the stored or obtained information and/or data. In some embodiments, the processor 110 may be implemented on a cloud platform. For example, the cloud platform may include a private cloud, a public cloud, a hybrid cloud, a community cloud, a distributed cloud, an internal cloud, a multi-layer cloud, or the like, or any combination thereof. In some embodiments, the processor 110 may be a distributed server group, which may include a plurality of server nodes.

The network 120 may include any suitable network for information and/or data exchange in the application scenario 100. In some embodiments, one or more components of the application scenario 100 (e.g., the terminal 130, the processor 110, and the memory 140) may transmit the information and/or data to one or more other components of the application scenario 100 via the network 120. For example, the processor 110 may obtain relevant information from the memory 140 via the network 120.

In some embodiments, the network 120 may be a wired network, a wireless network, or a combination thereof. In some embodiments, the network may be various topologies such as peer-to-peer, shared, centralized, or the like, or a combination of a plurality of topologies.

The terminal 130 may include a mobile device 130-1, a tablet computer 130-2, a laptop computer 130-3, or the like, or any combination thereof. In some embodiments, the terminal 130 may interact with other components in the application scenario 100 via the network 120. For example, the terminal 130 may receive information and/or instructions input by the user, and transmit the received information and/or instructions to the processor 110 via the network 120.

In some embodiments, the application scenario 100 also includes a preset client application, which may be software or an application installed on the terminal 130. For example, it may be a mobile phone application installed on the mobile device 130-1, a desktop application of the laptop computer 130-3, or the like. In some embodiments, the client application includes a graphical user interface to achieve interaction with the user 150. For example, one or more candidate task entries are displayed in the graphical user interface for selection by the user.

The memory 140 may store data and/or instructions. In some embodiments, the memory 140 may store the data obtained from the processor 110 and the terminal 130. For example, the memory 140 may store the data obtained from the terminal 130, or the like.

In some embodiments, the memory 140 may store the data and/or instructions for the processor 110 to perform an exemplary process described in some embodiments of the present disclosure. For example, the memory 140 may store the instructions for the processor 110 to perform processes shown in the flowcharts. In some embodiments, the memory 140 may include a mass memory, a removable memory, a volatile read/write memory, a read-only memory (ROM), or the like, or any combination thereof. In some embodiments, the memory 140 may be implemented on the cloud platform. In some embodiments, the memory 140 may be a portion of the processor 110.

The user 150 refers to personnel who perform task order creation. For example, the user 150 is a work order creator from units such as a general contractor, a subcontractor, and a work team of a construction project. In some embodiments, the user 150 may perform relevant operations through the client application installed on the terminal 130, collaborate with the processor 110 in data processing and/or instruction execution, and implement the method for creating a construction task order.

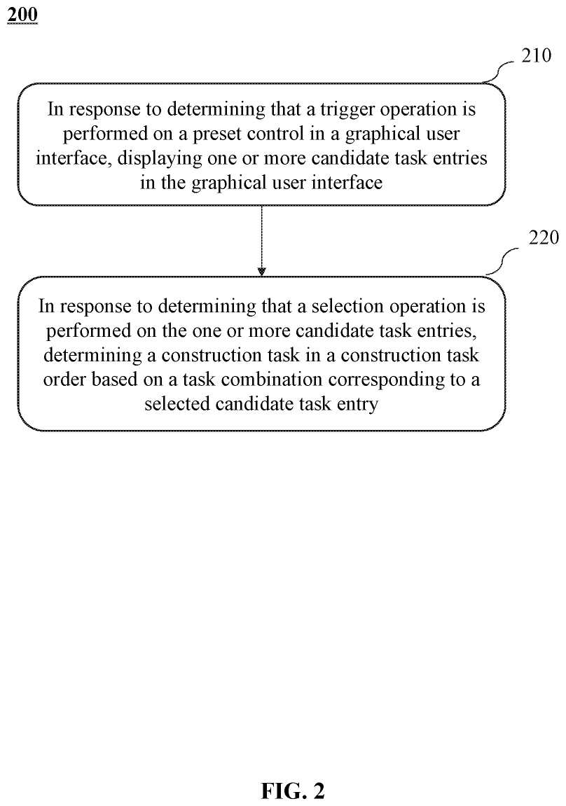

More details about the above relevant parameters (e.g., the construction task item, the graphical user interface, the candidate task entry, or the like) may be referred to in relevant descriptions of FIGS. 2-8 below.

The above description is merely for illustrative purposes, and actual application scenarios may have various variations.

It should be noted that the application scenario 100 of the method for creating a construction task order is provided merely for illustrative purposes, and is not intended to limit the scope of the present disclosure. For a person having ordinary skill in the art, a plurality of modifications or variations may be made based on the description of the present disclosure. However, the modifications and variations will not depart from the scope of the present disclosure.

FIG. 2 is a flowchart illustrating an exemplary process for creating a construction task order according to some embodiments of the present disclosure. In some embodiments, the method for creating a construction task order may be applied to a computing device having a graphical user interface and a memory. The computing device may be the terminal described in FIG. 1, or other devices having computing and display functions.

As shown in FIG. 2, the process 200 includes the following operations. In some embodiments, the process 200 may be executed by a processor.

In 210, in response to determining that a trigger operation is performed on a preset control in the graphical user interface, the processor may display one or more candidate task entries in the graphical user interface.

The graphical user interface refers to a display and operation interface for interacting with a user, for example, a personal computer (PC)-side webpage interface of a client application, a mobile application (APP) interface, or the like.

The preset control refers to a control component preset in the graphical user interface, for example, a button, a slider, an input box, or the like. The trigger operation on the preset control may include clicking a button, dragging a slider, filling content in an input box, or a mouse cursor hovering in an input box. In some embodiments, the user may trigger a corresponding instruction or event by the trigger operation on the preset control, thereby realizing interaction with the processor.

The candidate task entry refers to a candidate construction task entry. In some embodiments, the candidate task entry may include a task combination formed based on a plurality of construction task items. In some embodiments, the task combination may further include task characteristics corresponding to the plurality of construction task items.

The construction task item refers to a productive task item in a construction process. Different units have different dispatch granularities, and correspond to different task combinations. For example, a subcontractor has a larger dispatch granularity. Construction task items with a larger granularity may include, for example, rebar engineering, formwork engineering, concrete engineering, or the like. A work team has a smaller dispatch granularity. Construction task items with a smaller granularity may include, for example, rebar straightening, rebar cutting, rebar bending and forming, or the like. In the present disclosure, the construction task items refer to task items of leaf nodes in a construction task tree, namely, the aforementioned construction task items with a smaller granularity.

The task characteristic is characteristic information of the construction task item, and may be understood as a further description of the construction task item. For example, the task characteristic corresponding to a tile laying task item may include a tile specification, a tile material, or the like.

Illustratively, the candidate task entry 1 may be represented as: {task combination 1 [(construction task item 1, task characteristic 1), (construction task item 2, task characteristic 2), . . . , (construction task item S, task characteristic S)]}.

In some embodiments, in response to determining that the trigger operation is performed on the preset control in the graphical user interface, the processor may display the one or more candidate task entries in the graphical user interface.

For example, when the user clicks a construction task button in a task order creation interface, the processor may generate one or more candidate task entries and display the one or more candidate task entries next to the construction task button. As another example, when the user clicks a dispatch button in a contract information interface, the processor may generate one or more candidate task entries and display the one or more candidate task entries in a blank field.

In some embodiments, in response to determining that the user performs a trigger operation on the preset control in the graphical user interface, the processor may read one or more candidate task entries from a task entry set pre-stored in the memory, and display the one or more candidate task entries in the graphical user interface. Each candidate task entry in the task entry set includes a task combination formed based on a plurality of construction task items, and the task entry set is pre-constructed by aggregating a plurality of pieces of historical task data and stored in the memory; and

In some embodiments, the processor may randomly select one or more construction task entries from the task entry set pre-stored in the memory, as the one or more candidate task entries.

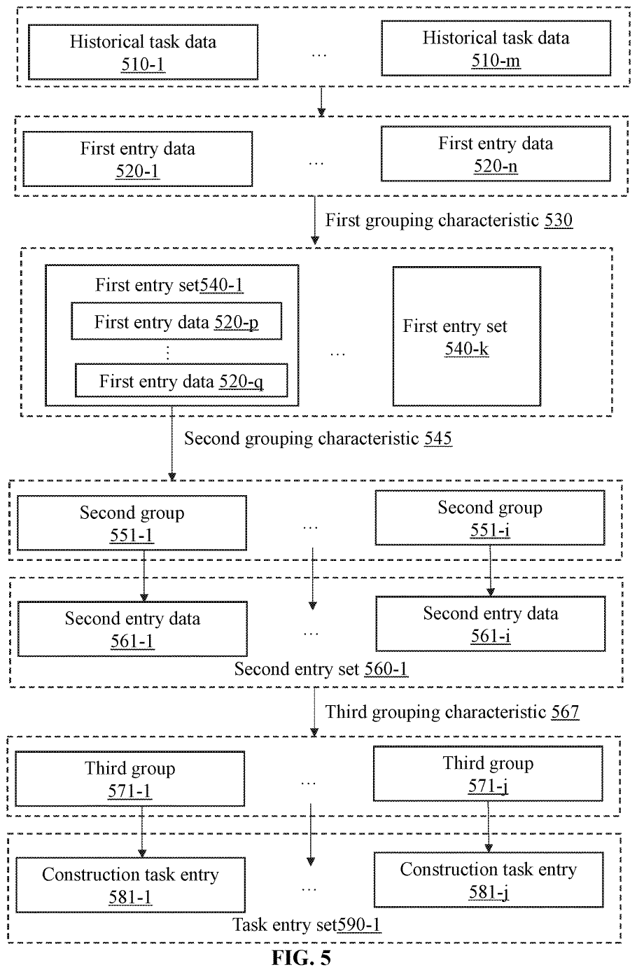

More descriptions regarding a process for obtaining the task entry set may be found in related description of FIG. 5.

In 220, in response to determining that a selection operation is performed on the one or more candidate task entries, the processor may determine a construction task in a construction task order based on a task combination corresponding to a selected candidate task entry.

In some embodiments, in response to determining that the user performs the selection operation on the one or more candidate task entries displayed in the graphical user interface, the processor may write the task combination corresponding to the selected candidate task entry into the construction task order to determine the construction task.

In some embodiments, the user may select a candidate task entry by a plurality of selection operations (e.g., clicking the candidate task entry for selection). The processor may automatically fill a plurality of construction task items included in the task combination of the candidate task entry selected by the user (also referred to as the selected candidate task entry) into the construction task of the construction task order.

In some embodiments, the processor may further determine at least one of a pricing manner or a measurement unit price in the construction task order based on a selected representative cost of the selected candidate task entry. More descriptions regarding this part may be found in the detailed description below.

In some embodiments of the present disclosure, in response to determining that the trigger operation is performed on the preset control in the graphical user interface, the candidate task entries are intelligently recommended and displayed. Furthermore, based on the task combination of the candidate task entry selected by the user, the construction task in the construction task order is quickly determined. This avoids the user manually selecting the construction task items one by one when creating the task order, thereby improving order creation efficiency.

In some embodiments, in different application scenarios of the method for creating a construction task order, the graphical user interface may be different interfaces, and the preset control in the graphical user interface may be different controls. For example, when the user creates a task order in a task management bar of a client application (denoted as scenario one), the graphical user interface may be the task order creation interface, and the preset control may be a construction task control. As another example, when the user dispatches after creating a contract in a contract management bar of the client application (denoted as scenario two), the graphical user interface may be the contract information interface, and the preset control may be a dispatch control.

The task order creation interface refers to an interface for creating a task order. The contract information interface refers to an interface for displaying contract information. The construction task control refers to a control for triggering a construction task determination work. The dispatch control refers to a control for triggering a dispatch task.

In some embodiments, in scenario one, when the user does not input information related to the construction task, in response to determining that the user performs a trigger operation on the construction task control in the task order creation interface, the processor may determine one or more candidate task entries and display the one or more candidate task entries.

For example, when the user does not input the information related to the construction task and only clicks the construction task button in the task order creation interface, the processor may generate one or more candidate task entries and display the one or more candidate task entries next to the construction task button.

In some embodiments, the processor may determine the one or more candidate task entries and display the one or more candidate task entries by a plurality of manners. For example, the processor may randomly select one or more construction task entries from the task entry set as the one or more candidate task entries, and display the one or more candidate task entries in the corresponding interface.

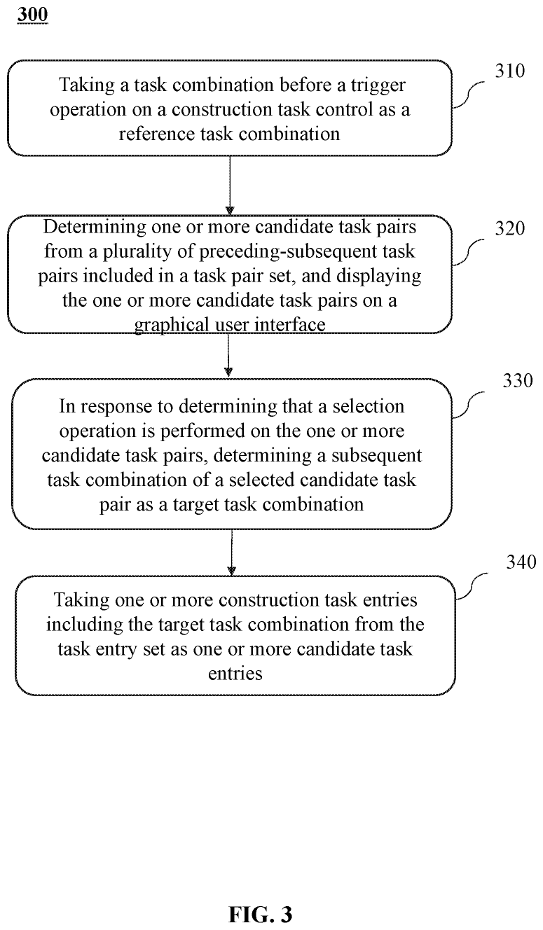

In some embodiments, the processor may further: take a task combination before the trigger operation on the construction task control as a reference task combination; determine one or more candidate task pairs from a plurality of preceding-subsequent task pairs included in a task pair set, and display the one or more candidate task pairs on the graphical user interface; in response to determining that the user performs a selection operation on the one or more candidate task pairs, determine a subsequent task combination of a selected candidate task pair as a target task combination; and take one or more construction task entries including the target task combination from the task entry set as the one or more candidate task entries. More descriptions regarding this part may be found in the related description of FIG. 3.

In some embodiments of the present disclosure, when the construction task control is triggered, determining and displaying the candidate task entries can intelligently recommend available construction task entries for selection when the user does not input construction task items and/or task characteristics, thereby improving the order creation efficiency.

In some embodiments, in scenario one, when the user partially inputs, the processor may: in response to determining that a trigger operation is performed on the construction task control in the task order creation interface, display a task tree interface; in response to determining that a trigger operation is performed on one or more task nodes in the task tree interface, determine one or more specified task items; and determine the one or more candidate task entries based on the one or more specified task items, and display the one or more candidate task entries.

The task tree interface refers to an interface that includes the construction task tree. The construction task tree refers to tree-shaped data formed by arranging the construction task items in the construction process according to hierarchical relationships. The construction task tree includes a plurality of task nodes, and each task node includes one or more construction task items.

The specified task item refers to a construction task item corresponding to a selected task node. In some embodiments, in response to determining that the user expands one or more task nodes in the task tree interface and clicks to select one or more specified task items under the one or more task nodes, the processor may determine the one or more specified task items.

In some embodiments, the processor may determine one or more candidate task entries based on the one or more specified task items and display the one or more candidate task entries through a plurality of manners. For example, the processor may obtain one or more construction task entries including the one or more specified task items from the task entry set, determine the one or more construction task entries as the one or more candidate task entries, and display the one or more candidate task entries in the graphical user interface.

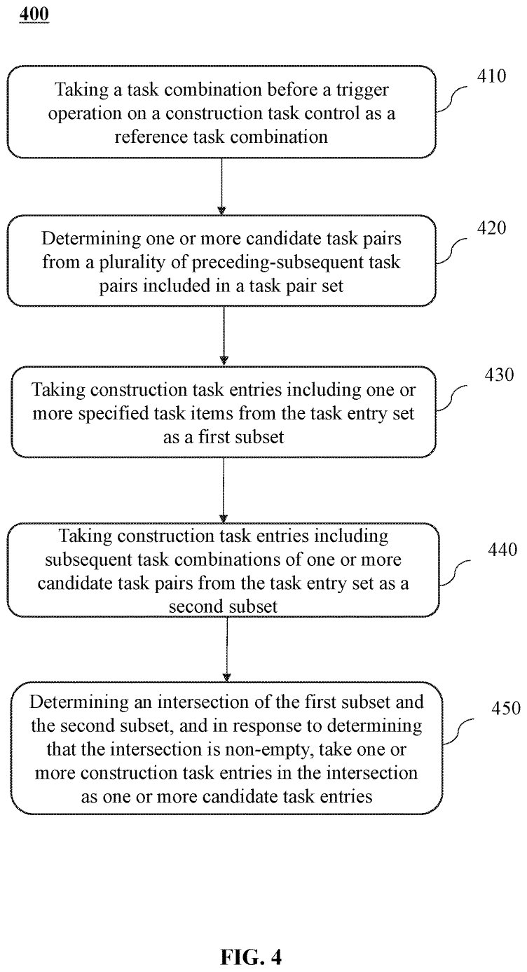

In some embodiments, the processor may take the task combination before the trigger operation on the construction task control as the reference task combination; determine the one or more candidate task pairs from the plurality of preceding-subsequent task pairs included in the task pair set; take construction task entries including the one or more specified task items from the task entry set as a first subset; take construction task entries including subsequent task combinations of the one or more candidate task pairs from the task entry set as a second subset; and determine an intersection of the first subset and the second subset, and in response to determining that the intersection is non-empty, take one or more construction task entries in the intersection as the one or more candidate task entries. More descriptions regarding this part may be found in in the related description of FIG. 4.

In some embodiments of the present disclosure, the task tree interface is displayed when the construction task control is triggered, and the one or more specified task items are determined when a task node in the task tree interface is triggered, and subsequently the one or more candidate task entries are determined and displayed, which can intelligently recommend construction task entries satisfying known user requirements for the user to select, in a case where the user inputs partial information, avoid the user from manually selecting construction task items and their corresponding task characteristics one by one, thereby improving task order creation efficiency.

In some embodiments, the processor may automatically fill a plurality of construction task items included in the task combination of the candidate task entry selected by the user into the construction task of the construction task order.

In some embodiments, each candidate task entry may include a plurality of representative costs and corresponding probability values. That is, a candidate task entry includes a task combination, a plurality of representative costs, and the probability value corresponding to each representative cost respectively.

Illustratively, candidate task entry 1 may be represented as: [“task combination 1”, (“representative cost 1-1”: “probability value 1-1”), . . . , (“representative cost 1-r”: “probability value 1-r”)]. r represents r representative costs.

The representative cost refers to an estimated value of the cost that can reasonably characterize the task combination of the candidate task entry.

The probability value refers to an occurrence probability corresponding to the representative cost.

In some embodiments, the candidate task entry belongs to the task entry set. More descriptions regarding the process for obtaining the task entry set may be found in the related description of FIG. 5 below.

In some embodiments, each representative cost corresponds to a pricing manner, a measurement unit, and a measurement unit price.

The pricing manner refers to a manner for determining a cost, for example, by piece, by hour, by work area, etc. In the present disclosure, the cost refers to a labor cost.

The measurement unit may include block, ton, hour, day, etc., corresponding to the pricing manner.

The measurement unit price refers to a specific value of the unit price, and may be pre-determined by a human and uploaded to the processor. The measurement unit price is related to the pricing manner and the measurement unit. For example, the measurement unit price for laying a ceramic tile of 80 cm*80 cm specification is 30 yuan/piece.

In some embodiments, the processor may, in response to determining that a selection operation is performed on a representative cost of the selected candidate task entry, determine at least one of a pricing manner or a measurement unit price in the construction task order based on the selected representative cost.

For example, in response to determining that the user clicks a selection box of a certain representative cost of the selected candidate task entry, the processor may automatically fill the pricing manner and the measurement unit price corresponding to the selected representative cost into the pricing manner and the measurement unit price in the construction task order, respectively.

In some embodiments of the present disclosure, the user further selects a representative cost of the selected candidate task entry, so that after automatically filling the construction task in the construction task order based on the task combination of the selected candidate task entry, the processor may further automatically fill the pricing manner and unit price information in the construction task order based on the selected representative cost, thereby improving the intelligence of task order creation and increasing task order creation efficiency.

In some embodiments, in scenario two, in response to determining that the user performs a trigger operation on the dispatch control in the contract information interface, the processor may read the one or more candidate task entries from the task entry set pre-stored in the memory. That is, in response to determining that the trigger operation is performed on the dispatch control in the contract information interface, the processor may determine one or more candidate task entries and display the one or more candidate task entries.

For example, in response to determining that the user clicks the dispatch button in the contract information interface, the processor may generate one or more candidate task entries and display the one or more candidate task entries in the blank field.

In some embodiments of the present disclosure, determining and displaying candidate task entries when the dispatch control is triggered can intelligently recommend available construction task entries for the user to select, in a case where the user views contract information and has a dispatch demand, thereby improving dispatch efficiency.

In some embodiments, each candidate task entry corresponds to a create-task-order control. The processor can, in response to determining that a trigger operation on the create-task-order control corresponding to the candidate task entry, determine the selected candidate task entry, display a task order creation interface corresponding to the selected candidate task entry, and determine the construction task in the construction task order based on the task combination of the selected candidate task entry.

The create-task-order control refers to a control that triggers a task order creation work of a construction task order. In some embodiments, after the dispatch control is triggered, the processor may display one or more candidate task entries in the contract information interface. Each candidate task entry corresponds to a create-task-order control. The user triggers the create-task-order control to select a corresponding candidate task entry. After the candidate task entry is selected, the processor may display the task order creation interface corresponding to the selected candidate task entry through a jump or pop-up window, etc., and automatically fill a plurality of construction task items included in the task combination of the selected candidate task entry into the construction task of the construction task order.

In some embodiments of the present disclosure, after the dispatch control is triggered to determine and display candidate task entries, convenient interface switching is performed through the create-task-order control corresponding to each candidate task entry. This allows quickly entering the task order creation interface corresponding to the selected candidate task entry and automatically filling the construction task in the construction task order, thereby improving dispatch and task order creation efficiency.

In some embodiments, each candidate task entry may include a plurality of representative costs and corresponding probability values. The processor may, in response to determining that a trigger operation is performed on the create-task-order control, determine at least one of a pricing manner or a measurement unit price in the construction task order based on the representative costs of the candidate task entry corresponding to the create-task-order control.

In some embodiments, each candidate task entry corresponds to a plurality of create-task-order controls, and each representative cost of the candidate task entry corresponds to a create-task-order control. In response to determining that the user triggers a create-task-order control, a representative cost of the candidate task entry corresponding to the create-task-order control may be determined. The processor may automatically fill the pricing manner and the measurement unit price corresponding to the selected representative cost into the pricing manner and the measurement unit price in the construction task order, respectively.

In some embodiments of the present disclosure, the user may directly select a representative cost of a candidate task entry through the create-task-order control. This enables the processor to quickly and automatically fill the construction task, the pricing manner, and unit price information in the construction task order directly based on the task combination and the representative cost of the selected candidate task entry, thereby further improving the efficiency of dispatch and task order creation.

FIG. 3 is a flowchart illustrating an exemplary process for determining one or more candidate task entries according to some embodiments of the present disclosure. As shown in FIG. 3, the process 300 includes the following operations. In some embodiments, the process 300 may be performed by the processor.

In 310, the processor may take a task combination before a trigger operation on a construction task control as a reference task combination.

In some embodiments, the processor may obtain a plurality of task combinations of a plurality of historical construction task orders before the trigger operation on the construction task control from the memory. From these, the processor may determine a task combination of a historical construction task order generated at a time closest to the current time under the same project section, and take the task combination as the reference task combination. Alternatively, the processor may select therefrom a task combination of a historical construction task order whose unit type of a creator is consistent with a unit type of a current user, and take the task combination as the reference task combination.

The project section refers to a subdivision of a project. According to a division by construction time or construction area, a project may be divided into at least two project sections. For example, a certain housing construction project may be subdivided into Section 1 and Section 2. The unit type may include general contractors, subcontractors, work teams, etc., involved in the construction project.

In 320, the processor may determine one or more candidate task pairs from a plurality of preceding-subsequent task pairs included in a task pair set, and display the one or more candidate task pairs on a graphical user interface.

The task pair set includes the plurality of preceding-subsequent task pairs. In some embodiments, the preceding-subsequent task pairs may be pre-stored in the memory, and the processor may directly retrieve the preceding-subsequent task pairs from the memory.

In some embodiments, each preceding-subsequent task pair may include a preceding task combination, a subsequent task combination, and a probability value, and the candidate task pair may be a preceding-subsequent task pair whose preceding task combination is the same as the reference task combination. The preceding task combination and the subsequent task combination are temporally adjacent, and the subsequent task combination is later in time.

In some embodiments, the processor may select a plurality of candidate task pairs having higher probability values from the one or more preceding-subsequent task pairs whose preceding task combination is the same as the reference task combination, and display the plurality of candidate task pairs on the graphical user interface.

In 330, in response to determining that a selection operation is performed on the one or more candidate task pairs, the processor may determine a subsequent task combination of a selected candidate task pair as a target task combination.

In some embodiments, when the user selects a candidate task pair (for example, by clicking a selection button corresponding to the candidate task pair), the processor may determine the subsequent task combination in the candidate task pair as the target task combination.

In 340, the processor may take one or more construction task entries including the target task combination from the task entry set as the one or more candidate task entries.

In some embodiments, the processor may select one or more construction task entries that include the target task combination from the task entry set, and take all or a portion of the one or more construction task entries as the candidate task entries.

In some embodiments of the present disclosure, by determining the reference task combination and determining the candidate task pairs from the task pair set, and further determining the subsequent task combination of the selected candidate task pair as the target task combination, and taking the construction task entries in the task entry set that include the target task combination as the candidate task entries, candidate task entries with higher adaptability are recommended to the user for selection based on the previous task combination when the user has zero input, which is beneficial for improving the recommendation accuracy of the candidate task entries, thereby improving the task order creation efficiency.

FIG. 4 is a flowchart illustrating another exemplary process for determining one or more candidate task entries according to some other embodiments of the present disclosure. As shown in FIG. 4, the process 400 includes the following operations. In some embodiments, the process 400 may be executed by the processor.

In 410, the processor may take a task combination before a trigger operation on a construction task control as a reference task combination.

Operation 410 is the same as operation 310, and may refer to the related description of FIG. 3.

In 420, the processor may determine one or more candidate task pairs from a plurality of preceding-subsequent task pairs included in a task pair set.

Operation 420 is similar in content to operation 320, and may refer to the related description of FIG. 3.

In 430, the processor may take construction task entries including one or more specified task items from the task entry set as a first subset.

In some embodiments, the processor may select one or more construction task entries that include the specified task items from the task entry set, to construct the first subset. More descriptions regarding the specified task items may be found in related description of FIG. 2.

In 440, the processor may take construction task entries including subsequent task combinations of one or more candidate task pairs from the task entry set as a second subset.

In some embodiments, the processor may select one or more construction task entries that include the subsequent task combinations of the candidate task pairs from the task entry set, to construct the second subset.

In 450, the processor may determine an intersection of the first subset and the second subset, and in response to determining that the intersection is non-empty, take one or more construction task entries in the intersection as the one or more candidate task entries.

In some embodiments, if the intersection of the first subset and the second subset is not an empty set, the processor may take the construction task entries in the intersection as the candidate task entries.

In some embodiments of the present disclosure, by determining the reference task combination and determining the candidate task pairs from the task pair set, and further taking the construction task entries that include the specified task items and the subsequent task combinations of the candidate task pairs as the candidate task entries, candidate task entries with higher adaptability are recommended to the user for selection when the user inputs a portion of the construction task, which is beneficial for improving the recommendation accuracy of the candidate task entries, thereby improving the task order creation efficiency.

In some embodiments, in response to determining that the intersection is empty, the processor may determine one or more target arrays including the one or more specified task items from an array set, and sort the one or more target arrays in descending order of occurrence frequency; wherein the array set includes one or more arrays, and each array includes a low-weight task item and an occurrence frequency of the low-weight task item. The processor may further remove a specified task item corresponding to a target array with a highest occurrence frequency; and re-determine the intersection of the first subset and the second subset based on remaining specified task items until the intersection is non-empty.

In some embodiments, the array set may include one or more arrays, and each array includes a low-weight task item and a corresponding occurrence frequency.

In some embodiments, the arrays may be pre-stored in the memory, and the processor may directly retrieve the arrays from the memory.

In some embodiments, when the intersection of the first subset and the second subset is empty, the processor may determine the one or more target arrays including the specified task items from the array set, and sort the one or more target arrays in descending order of occurrence frequency; remove the specified task item contained in the target array with the highest occurrence frequency; re-determine the first subset according to operation 430 based on the remaining specified task items, and further re-determine the intersection of the first subset and the second subset; if the intersection is non-empty, take the construction task entries in the intersection as the candidate task entries; if the intersection is empty, repeat the above operations until the intersection is non-empty.

In some embodiments of the present disclosure, the task items of the arrays in the array set are the low-weight task items determined based on prior knowledge. By determining the target arrays and partially removing the specified task items to re-determine the intersection of the first subset and the second subset, candidate task entries with higher adaptability may still be recommended to the user for selection even when the intersection is empty, which improves the completeness of the solution for determining the candidate task entries, thereby improving the task order creation efficiency.

In some embodiments, the method for creating a construction task order may further include: obtaining the task entry set. The task entry set includes a plurality of construction task entries, and the candidate task entries belong to the task entry set.

FIG. 5 is a schematic diagram illustrating an exemplary process for obtaining a task entry set according to some embodiments of the present disclosure.

In some embodiments, as shown in FIG. 5, the processor may generate a plurality of pieces of first entry data (first entry data 520-1, . . . , first entry data 520-n) based on a plurality of pieces of historical task data (historical task data 510-1, . . . , historical task data 510-m), and divide the plurality of pieces of first entry data into one or more first entry sets (a first entry set 540-1, . . . , a first entry set 540-k) according to a first grouping characteristic 530; wherein the first grouping characteristic includes a unit type, and each piece of first entry data includes a historical task combination, cost data, and a frequency. For each first entry set (for example, the first entry set 540-1), the processor may divide a plurality of pieces of first entry data (for example, first entry data 520-p, first entry data 520-q, . . . ) in the first entry set 540-1 into a plurality of second groups (for example, a second group 551-1, . . . , a second group 551-i) according to a second grouping characteristic 545, and generate a plurality of pieces of second entry data (for example, second entry data 561-1, . . . , second entry data 561-i) corresponding to the plurality of second groups respectively to construct a second entry set (for example, a second entry set 560-1 constructed from the second entry data 561-1, . . . , second entry data 561-i in the first entry set 540-1) based on the plurality of pieces of second entry data from each first entry set. The second grouping characteristic includes the historical task combination, a pricing manner, a measurement unit, and the cost data, and each piece of second entry data includes the historical task combination, a representative cost, and a representative frequency. The processor may further divide a plurality of pieces of second entry data in the second entry set into a plurality of third groups (for example, a third group 571-1, . . . , a third group 571-j) according to a third grouping characteristic 567, and generating a plurality of construction task entries (for example, a construction task entry 581-1, . . . , a construction task entry 581-j) corresponding to the plurality of third groups, respectively, to construct the task entry set (for example, a task entry set 590-1). The third grouping characteristic includes the historical task combination, and each construction task entry includes the historical task combination, a plurality of representative costs, and a representative frequency and a probability value corresponding to each representative cost respectively.

In some embodiments, the processor may transmit the constructed task entry set to the memory for storage, so as to be invoked when the processor executes the method for creating a construction task order.

The historical task data may include a historical construction task order and/or a historical list item. A list item refers to an information item in a contract. In some embodiments, in response to determining that a trigger operation is performed on the create-list-item control in the contract information interface, the processor may display a graphical user interface for creating a list item corresponding to the contract, and the user may complete the creation of the list item in the graphical user interface. In some embodiments, the content of the list item may be substantially similar to the content of the construction task order.

In some embodiments, the processor may retrieve the historical construction task order and the historical list item in the historical data from the memory, to obtain the historical task data.

The first entry data may include the historical task combination, the cost data, and the frequency.

The cost data refers to a cost value for construction according to the historical task combination. The cost data may be represented by a product of a measurement unit price and a required amount (or actual amount).

The frequency refers to a count of occurrences of a historical task combination in the historical task data (for example, the historical task data in a certain historical time period). In some embodiments, the frequency may also specifically refer to a count of co-occurrences of the historical task combination and the cost data in the historical task data.

In some embodiments, the processor may, based on the plurality of pieces of historical task data, extract or determine a plurality of historical task combinations and cost data, and statistically obtain the corresponding frequencies to generate the plurality of pieces of first entry data.

In some embodiments, each piece of first entry data may further include a unit type and a creation time. For example, a piece of first entry data may be represented as [a unit type, a historical creation time, a historical task combination, cost data, a frequency].

The historical creation time may be a creation time of historical task data corresponding to a historical task combination and cost data in a piece of first entry data. In some embodiments, one piece of first entry data may be constructed based on a plurality of pieces of historical task data. In this case, the processor may take an average value of creation times of a plurality of pieces of historical task data used to construct a piece of first entry data as the historical creation time corresponding to the piece of first entry data. The average value of the creation times of the plurality of pieces of historical task data is an average value of creation times of a plurality of historical construction task orders and/or historical list items corresponding to the co-occurrence of the historical task combination and the cost data of the piece of first entry data.

The first grouping characteristic refers to a characteristic for grouping the plurality of pieces of first entry data to divide the one or more first entry sets. The first grouping characteristic may include a unit type. In some embodiments, the processor may divide the plurality of pieces of first entry data into the one or more first entry sets according to the first grouping characteristic. Each of the first entry sets includes a plurality of pieces of first entry data having the same unit type, and the plurality of pieces of first entry data in different first entry sets have different unit types.

In some embodiments, the processor may also adjust the frequency of a piece of first entry data based on the historical creation time corresponding to the piece of first entry data.

The process for adjusting the frequency of the piece of first entry data based on the historical creation time corresponding to the piece of first entry data may include a plurality of manners. For example, the processor may retrieve a preset adjustment model (e.g., a linear function, a quadratic function, etc.) to adjust the frequency of the piece of first entry data. An input of the adjustment model may be the frequency and the historical creation time of the piece of first entry data, and an output of the adjustment model may be an adjusted frequency of the piece of first entry data.

In some embodiments, when a difference between the historical creation time corresponding to the piece of first entry data and the current time is within a preset time range, the processor may increase the frequency of the piece of first entry data by a preset adjustment amount; when the difference between the historical creation time corresponding to the piece of first entry data and the current time exceeds the preset time range, the processor may decrease the frequency of the piece of first entry data by the preset adjustment amount; and the preset adjustment amount is positively correlated with the difference.

The preset time range may be set by a system default setting or by manual presetting, for example, three years, five years, etc. The difference between the historical creation time and the current time being within the preset time range refers to that a time interval between the historical creation time and the current time does not exceed the preset time range. A piece of first entry data whose difference is within the preset time range is more effective than a piece of first entry data whose difference exceeds the preset time range. The processor may increase the frequency of the former by the preset adjustment amount and decrease the frequency of the latter by the preset adjustment amount.

The preset adjustment amount may be positively correlated with the difference. The greater the difference, the longer the historical creation time corresponding to the piece of first entry data is from the current time, and the worse the representativeness and effectiveness of the piece of first entry data, the greater the preset adjustment amount may be, so as to result in a larger adjustment to the frequency of the piece of first entry data.

In some embodiments of the present disclosure, the frequency is adjusted based on the historical creation time corresponding to the piece of first entry data. Specifically, the older the first entry data, the larger the corresponding frequency reduction amount, which avoids data with poor effectiveness from occupying a larger weight, so that the candidate task entries subsequently provided to the user may be more aligned with the current situation, thereby improving the recommendation accuracy of the candidate task entries.

The second grouping characteristic refers to a characteristic for further grouping the plurality of pieces of first entry data in the first entry set to divide the plurality of second groups. The second grouping characteristic may include the historical task combination, the pricing manner, the measurement unit, and the cost data.

In some embodiments, for each first entry set, the processor may divide the plurality of pieces of first entry data in the first entry set into a plurality of second groups according to the second grouping characteristic. Each second group includes a plurality of pieces of first entry data having the same historical task combination, the same pricing manner, the same measurement unit, and the similar cost data.

In some embodiments, the processor may generate a plurality of pieces of second entry data corresponding to the plurality of second groups respectively based on the plurality of second groups in each first entry set. Each second group generates a piece of second entry data.

Each piece of second entry data includes the historical task combination, the representative cost, and the representative frequency. Exemplarily, a piece of second entry data may be represented as [“historical task combination”, “representative cost”, “representative frequency”].

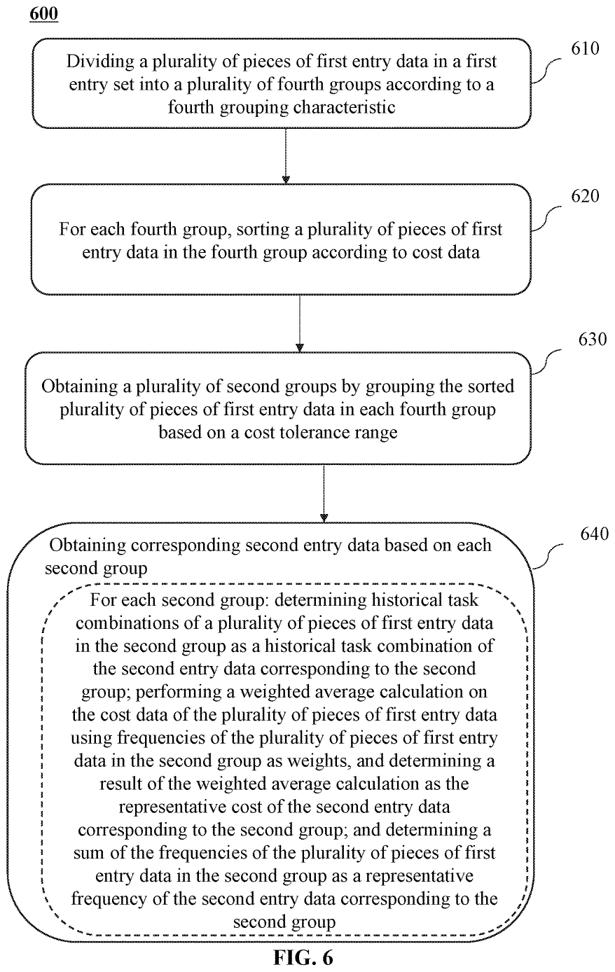

FIG. 6 is a flowchart illustrating an exemplary process for generating second entry data according to some embodiments of the present disclosure. As shown in FIG. 6, the process 600 includes the following operations. In some embodiments, the process 600 may be executed by the processor.

In 610, the processor may divide a plurality of pieces of first entry data in a first entry set into a plurality of fourth groups according to a fourth grouping characteristic.

The fourth grouping characteristic refers to a characteristic for grouping the plurality of pieces of first entry data in the first entry set to divide the plurality of fourth groups. The fourth grouping characteristic includes a historical task combination, a pricing manner, and a measurement unit.

In some embodiments, for each first entry set, the processor may divide a plurality of pieces of first entry data in the first entry set into a plurality of fourth groups according to the fourth grouping characteristic. Each fourth group includes a plurality of pieces of first entry data having the same historical task combination, the same pricing manner, and the same measurement unit.

In 620, for each fourth group, the processor may sort the plurality of pieces of first entry data in the fourth group according to cost data.

In some embodiments, the processor may sort the plurality of pieces of first entry data in each fourth group according to numerical values of the cost data from high to low or from low to high.

In 630, the processor may obtain a plurality of second groups by grouping the sorted plurality of pieces of first entry data in each fourth group based on a cost tolerance range.

The cost tolerance range refers to a difference range of the cost data of the plurality of pieces of first entry data within the same second group. In some embodiments, the cost tolerance range may be set by a system default setting or by manual presetting, for example, 5%.

In some embodiments, for each sorted fourth group, the processor may determine a ratio between the cost data of each piece of first entry data in the fourth group and the smallest cost data therein. The processor groups ratios based on the cost tolerance range to obtain a plurality of ratio groups, and divides a plurality of pieces of first entry data corresponding to a plurality of ratios within each ratio group into the same second group. For example, the ratios are grouped according to [1,1.05), [1.05,1.1), [1.1,1.15), etc. The plurality of pieces of first entry data corresponding to the ratio group [1,1.05) are divided into a second group, the plurality of pieces of first entry data corresponding to the ratio group [1.05,1.1) are divided into another second group, and a plurality of second groups are obtained accordingly from the plurality of ratio groups. Each second group includes a plurality of pieces of first entry data having the same historical task combination, the same pricing manner, the same measurement unit, and the similar cost data. The second groups obtained by dividing the plurality of fourth groups are merged to obtain the final second groups.

In 640, the processor may obtain corresponding second entry data based on each second group.

Operation 640 includes: for each second group: determining historical task combinations of a plurality of pieces of first entry data in the second group as a historical task combination of the second entry data corresponding to the second group; performing a weighted average calculation on the cost data of the plurality of pieces of first entry data using frequencies of the plurality of pieces of first entry data in the second group as weights, and determining a result of the weighted average calculation as the representative cost of the second entry data corresponding to the second group; and determining a sum of the frequencies of the plurality of pieces of first entry data in the second group as a representative frequency of the second entry data corresponding to the second group.

In some embodiments of the present disclosure, the plurality of pieces of first entry data in the fourth group have the same historical task combination, the same pricing manner, and the same measurement unit. The plurality of pieces of first entry data in the fourth group are then grouped again according to the cost tolerance range, so that the plurality of second groups having the same work but different costs may be obtained, which is more adaptable to a cost estimation of the construction task. The plurality of pieces of first entry data within each second group have the similar costs, which makes the determination of the representative cost and the representative frequency of the second entry data more accurate, so as to improve the recommendation accuracy of the subsequent candidate task entries.

In some embodiments, for each first entry set, the processor may obtain a plurality of pieces of second entry data corresponding to each of the plurality of second group, respectively, and construct the second entry set based on the plurality of pieces of second entry data. Each first entry set corresponds to a second entry set. Each second entry set includes a plurality of pieces of second entry data having the same unit property but different historical task combinations. Each piece of second entry data has its respective historical task combination, and the representative cost and the representative frequency corresponding to the historical task combination.

The third grouping characteristic refers to a characteristic for further grouping the plurality of pieces of second entry data in the second entry set to divide the plurality of third groups. The third grouping characteristic may include the historical task combination.

In some embodiments, for each second entry set, the processor may divide the plurality of pieces of second entry data in the second entry set into the plurality of third groups according to the third grouping characteristic. Each third group includes a plurality of pieces of second entry data having the same historical task combination.

In some embodiments, for each third group, the processor may determine a sum of representative frequencies of the plurality of pieces of second entry data in the third group; determine a probability value corresponding to each representative cost respectively based on the representative frequency of each piece of second entry data and the sum of the representative frequencies; and obtain a construction task entry based on the historical task combination of the plurality of pieces of second entry data in the third group, the plurality of representative costs, and the representative frequency and the probability value corresponding to each representative cost, respectively.

In some embodiments, for each piece of second entry data in the third group, the processor may determine a ratio of the representative frequency of the piece of second entry data to a sum of representative frequencies corresponding to the third group as the probability value corresponding to the representative cost of the piece of second entry data.

In some embodiments, when the plurality of pieces of second entry data included in the third group have the same historical task combination, the historical task combination is determined as a task combination of the construction task entry. Moreover, the plurality of representative costs of the plurality of pieces of second entry data in the third group, as well as the representative frequency and the probability value corresponding to each representative cost, are determined as the plurality of representative costs and the representative frequency and the probability value corresponding to each representative cost of the construction task entry.

In some embodiments of the present disclosure, when the pieces of second entry data in the third group have the same historical task combination and their respective representative costs, and when the user selects a task combination, by determining a cost distribution based on different pay for the same work, possible cost data and corresponding probabilities are further presented to the user to improve the recommendation accuracy of candidate task entries.

In some embodiments, for each second entry set, the processor may respectively obtain a plurality of construction task entries corresponding to the plurality of third groups, and construct the task entry set based on the plurality of construction task entries.

In some embodiments of the present disclosure, by performing multiple characteristic divisions, a plurality of groups are formed, and then a plurality of construction task entries are generated to construct the task entry set including various “unit type+task combination+representative cost+probability value”, which provides a large and reliable data basis for the recommendation of candidate task entries.

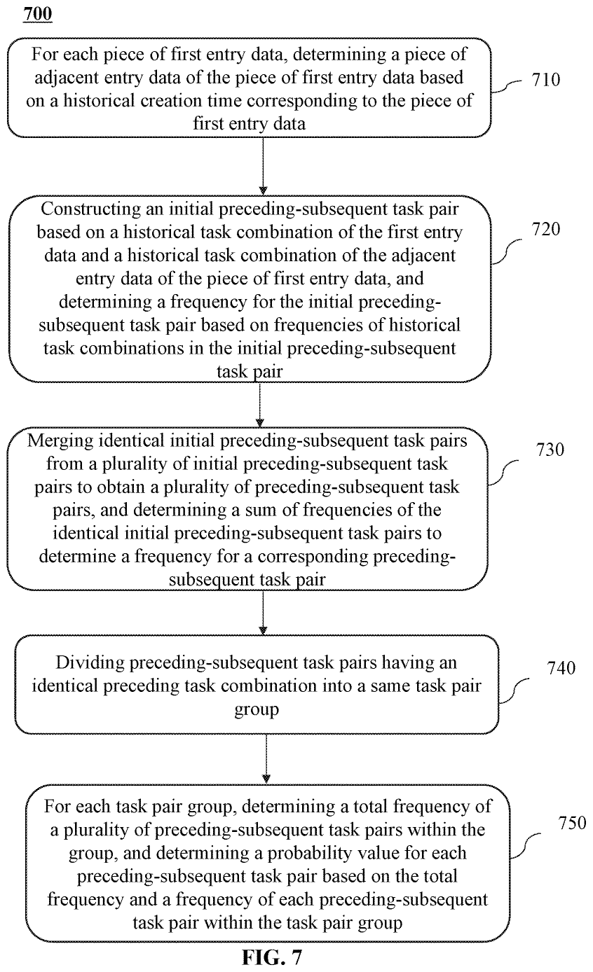

FIG. 7 is a flowchart illustrating an exemplary process for determining a preceding-subsequent task pair according to some embodiments of the present disclosure. As shown in FIG. 7, the process 700 includes the following operations. In some embodiments, the process 700 may be performed by the processor.

In 710, for each piece of first entry data, the processor may determine a piece of adjacent entry data of the piece of first entry data based on a historical creation time corresponding to the piece of first entry data.

In some embodiments, for each piece of first entry data, the processor may determine another piece of first entry data that is sequentially adjacent to and subsequent (or preceding) to the piece of first entry data based on the historical creation time, and take the another piece of first entry data as the adjacent entry data of the piece of first entry data.

Descriptions regarding the historical creation time corresponding to the first entry data may be found in relevant descriptions in FIG. 5.

In 720, the processor may construct an initial preceding-subsequent task pair based on the historical task combination of the first entry data and a historical task combination of the adjacent entry data of the piece of first entry data, and determine a frequency for the initial preceding-subsequent task pair based on frequencies of historical task combinations in the initial preceding-subsequent task pair.

In some embodiments, for each piece of first entry data, the processor may arrange the historical task combination of the piece of first entry data and the historical task combination of the adjacent entry data thereof in chronological order based on the historical creation time to construct the initial preceding-subsequent task pair; and select one of the frequencies of the two historical task combinations in the initial preceding-subsequent task pair (e.g., selecting a larger frequency or a smaller frequency, or randomly selecting a frequency) as the frequency for the initial preceding-subsequent task pair.

In some embodiments, the first entry data and its adjacent entry data may be two pieces of first entry data under the same project section. Taking the adjacent entry data that appears later in the sequence as an example: in some specific scenarios of project section constructions, under the same project section, the same piece of first entry data has only one piece of adjacent entry data; that is, under the same project section, only one initial preceding-subsequent task pair is constructed based on the historical task combination of the piece of first entry data and the historical task combination of the piece of adjacent entry data thereof. However, among a plurality of initial preceding-subsequent task pairs from a plurality of different project sections, the same initial preceding-subsequent task pairs (also referred to as identical initial preceding-subsequent task pairs) may appear.

In 730, the processor may merge identical initial preceding-subsequent task pairs from a plurality of initial preceding-subsequent task pairs to obtain a plurality of preceding-subsequent task pairs, and determine a sum of frequencies of the identical initial preceding-subsequent task pairs to determine a frequency for a corresponding preceding-subsequent task pair.

The preceding-subsequent task pair includes a preceding task combination, a subsequent task combination, and a frequency. A historical creation time corresponding to the preceding task combination precedes a historical creation time corresponding to the subsequent task combination.

In 740, the processor may divide preceding-subsequent task pairs having an identical preceding task combination into a same task pair group.

Each task pair group includes a plurality of preceding-subsequent task pairs having an identical preceding task combination and different subsequent task combinations.

In 750, for each task pair group, the processor may determine a total frequency of a plurality of preceding-subsequent task pairs within the group, and determine a probability value for each preceding-subsequent task pair based on the total frequency and a frequency of each preceding-subsequent task pair within the task pair group.

In some embodiments, for each task pair group, the processor may determine a sum of the frequencies of the plurality of preceding-subsequent task pairs within the task pair group to determine the total frequency; and determine a ratio of the frequency of each preceding-subsequent task pair to the total frequency, and determine the ratio as the probability value for each preceding-subsequent task pair.

The probability value of the preceding-subsequent task pair may characterize a probability that a corresponding subsequent task combination appears when a preceding task combination in the preceding-subsequent task pair appears.

In some embodiments of the present disclosure, by constructing preceding-subsequent task pairs, it is possible to accurately predict subsequent task combinations and corresponding probability values that may appear after a given preceding task combination, and precisely recommend reasonable candidate task entries to the user under conditions of zero input or partial input from the user, which facilitates improving the efficiency of order creation.

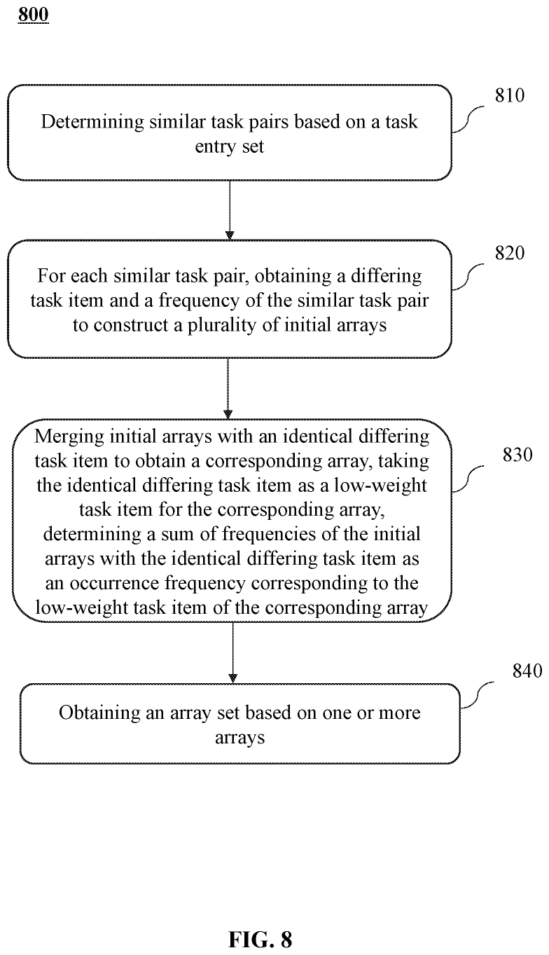

FIG. 8 is a flowchart illustrating an exemplary process for determining an array set according to some embodiments of the present disclosure. As shown in FIG. 8, the process 800 includes the following operations. In some embodiments, the process 800 may be performed by the processor.

In 810: the processor may determine similar task pairs based on a task entry set.

In some embodiments, a similar task pair may include two construction task entries satisfying a preset condition. The preset condition may include that: a count of differing task items between the two construction task entries does not exceed a preset count threshold, and probability values corresponding to representative costs, whose cost difference between the two construction task entries falls within a cost difference range, are all not lower than a probability threshold.

The count of differing task items between the two construction task entries refers to a count of different construction task items in the two construction task entries. The preset count threshold may be defaulted by a system or preset manually, for example, 2.

In some embodiments, the processor may determine the cost difference between a plurality of representative costs in the two construction task entries, and determine the representative costs whose cost difference is within the cost difference range. For example, a construction task entry W₁ includes three representative costs, namely U₁{U₁₁, U₁₂, U₁₃}, and a construction task entry W₂ includes three representative costs, namely U₂{U₂₁, U₂₂, U₂₃}. Each representative cost in U₂ is compared with each representative cost in U₁. If the cost difference between U₂₁ and U₁₂ is within the cost difference range, then the representative costs U₂₁ and U₁₂ are determined as the representative costs whose cost difference is within the cost difference range.

The cost difference may be represented by a ratio of an absolute difference between two representative costs to one of the representative costs (e.g., a larger value or a smaller value of the representative costs).

The cost difference range may be defaulted by a system or preset manually, for example, less than 10%.

In some embodiments, when the foregoing conditions are all satisfied, the processor may further determine two construction task entries whose probability values corresponding to representative costs having the cost difference within the cost difference range are not lower than the probability threshold as the similar task pair.

For example, assuming the cost difference range is less than 10% and the probability threshold is 40%, if the representative cost U₂₁ is 30 yuan and a corresponding probability value is 50%, and the representative cost U₁₂ is 31 yuan and a corresponding probability value is 45%; the difference between 30 and 31 is within 10%, which means the cost difference between representative costs U₂₁ and U₁₂ is within the cost difference range, and their corresponding probability values of 50% and 45% are both not lower than the probability threshold of 40%, and the count of differing task items between construction task entry W₁ and construction task entry W₂ is 1, which does not exceed the preset count threshold of 2, then the construction task entry W₁ and construction task entry W₂ form a similar task pair.

In some embodiments of the present disclosure, by limiting the count of differing task items, the cost difference of representative costs, and the probability values corresponding to the representative costs, similar task pairs satisfying multiple requirements may be selected.

In some embodiments, the processor may determine a plurality of construction task entries satisfying a preset condition from the task entry set to construct a plurality of similar task pairs.

In 820, for each similar task pair, the processor may obtain a differing task item and a frequency of the similar task pair to construct a plurality of initial arrays.

Each initial array includes a differing task item and a frequency corresponding to the similar task pair. In some embodiments, the processor may select any representative cost whose cost difference is within the cost difference range in the similar task pair, and determine the corresponding frequency thereof as the frequency of the similar task pair; and construct the plurality of initial arrays based on the differing task items and frequencies of the plurality of similar task pairs.

In 830, the processor may merge initial arrays with an identical differing task item to obtain a corresponding array, take the identical differing task item as a low-weight task item for the corresponding array, determine a sum of frequencies of the initial arrays with the identical differing task item as an occurrence frequency corresponding to the low-weight task item of the corresponding array.

More details regarding the low-weight task item and the corresponding occurrence frequency may be found in relevant descriptions if FIG. 4.

In 840, the processor may obtain an array set based on one or more arrays.

In some embodiments of the present disclosure, by determining the occurrence frequency corresponding to the low-weight task item, when user input information is excessive and no matching candidate task entries can be selected from the task entry set, the user input information may be reduced based on the low-weight task item and the occurrence frequency (e.g., by removing the low-weight task item with the highest occurrence frequency), thereby determining candidate task entries to be recommended, which improves the reliability of task combination recommendation and facilitates improving the efficiency of order creation.

Embodiments of the present disclosure also provide a method for obtaining a task entry set. In some embodiments, the method may be performed by the processor.

In some embodiments, the processor may generate a plurality of pieces of first entry data based on a plurality of pieces of historical task data, and divide the plurality of pieces of first entry data into one or more first entry sets according to a first grouping characteristic. The first grouping characteristic includes a unit type. Each piece of first entry data includes a historical task combination, cost data, and a frequency. For each first entry set, a plurality of pieces of first entry data in the first entry set are divided into a plurality of second groups according to a second grouping characteristic, and a plurality of pieces of second entry data corresponding to the plurality of second groups are respectively generated based on the plurality of second groups to construct a second entry set based on the plurality of pieces of first entry data in each first entry set. The second grouping characteristic includes the historical task combination, a pricing manner, a measurement unit, and the cost data. Each piece of second entry data includes the historical task combination, a representative cost, and a representative frequency. The plurality of pieces of second entry data in the second entry set are divided into a plurality of third groups according to a third grouping characteristic, and a plurality of construction task entries corresponding to the plurality of third groups are respectively generated based on the plurality of third groups to construct the task entry set. The third grouping characteristic includes the historical task combination. Each construction task entry includes the historical task combination, a plurality of representative costs, and a representative frequency and a probability value corresponding to each representative cost, respectively. More descriptions regarding this part may be found in the description related to FIG. 5.

The embodiments in the present disclosure are merely for illustration and description, and do not limit the scope of applicability of the present disclosure. For those skilled in the art, various modifications and changes that may be made under the guidance of the present disclosure are still within the scope of the present disclosure.

Furthermore, certain features, structures, or characteristics in one or more embodiments of the present disclosure may be appropriately combined.

In some embodiments, numbers describing component amounts or attribute quantities are used. It should be understood that such numbers used for embodiment descriptions are modified by the terms “approximately”, “approximated”, or “substantially” in some examples. Unless otherwise specified, “approximately”, “approximated”, or “substantially” indicate that the described numbers allow for a variation of ±20%. Accordingly, in some embodiments, the numerical parameters used in the description and claims are all approximate values, and the approximate values may change according to characteristics required by individual embodiments. In some embodiments, the numerical parameters should consider the specified significant digits and use a general manner of digit retention. Although numerical domains and parameters used to confirm the breadth of their scope in some embodiments of the present disclosure are approximate values, in specific embodiments, the setting of such numerical values is as precise as possible within a feasible range.

For each patent, patent application, patent application publication, and other materials referenced in the present disclosure, such as articles, books, specifications, publications, documents, etc., the entire content thereof is hereby incorporated by reference into the present disclosure. Except for application history documents inconsistent with or in conflict with the content of the present disclosure, and also except for documents that limit the broadest scope of claims of the present disclosure (currently or subsequently attached to the present disclosure). It should be noted that if descriptions, definitions, and/or use of terminology in auxiliary materials of the present disclosure are inconsistent with or in conflict with the content described in the present disclosure, the descriptions, definitions, and/or use of terminology in the present disclosure shall prevail.

What is claimed is:

1. A method for creating a construction task order, applied to a computing device having a graphical user interface and a memory, the method comprising:
in response to determining that a user performs a trigger operation on a preset control in the graphical user interface, reading one or more candidate task entries from a task entry set pre-stored in the memory by a processor, and displaying the one or more candidate task entries in the graphical user interface; wherein each candidate task entry in the task entry set includes a task combination formed based on a plurality of construction task items, and the task entry set is pre-constructed by aggregating a plurality of pieces of historical task data and stored in the memory; and
in response to determining that the user performs a selection operation on the one or more candidate task entries displayed in the graphical user interface, writing a task combination corresponding to a selected candidate task entry into a construction task order by the processor to determine a construction task.

2. The method of claim 1, wherein the graphical user interface includes a task order creation interface, and the preset control includes a construction task control; and
the in response to determining that a user performs a trigger operation on a preset control in the graphical user interface, reading one or more candidate task entries from a task entry set pre-stored in the memory by a processor includes:
in response to determining that the user performs a trigger operation on the construction task control in the task order creation interface, reading the one or more candidate task entries from the task entry set pre-stored in the memory by the processor.

3. The method of claim 2, wherein the reading the one or more candidate task entries from the task entry set pre-stored in the memory includes:
taking a task combination before the trigger operation on the construction task control as a reference task combination;
determining one or more candidate task pairs from a plurality of preceding-subsequent task pairs included in a task pair set, and displaying the one or more candidate task pairs on the graphical user interface; wherein each preceding-subsequent task pair includes a preceding task combination, a subsequent task combination, and a probability value, and a candidate task pair is a preceding-subsequent task pair whose preceding task combination is the same as the reference task combination;
in response to determining that the user performs a selection operation on the one or more candidate task pairs, determining a subsequent task combination of a selected candidate task pair as a target task combination; and
taking one or more construction task entries including the target task combination from the task entry set as the one or more candidate task entries.

4. The method of claim 1, wherein the graphical user interface includes a task order creation interface, and the preset control includes a construction task control;
the in response to determining that a user performs a trigger operation on a preset control in the graphical user interface, reading one or more candidate task entries from a task entry set pre-stored in the memory by a processor includes:
in response to determining that the user performs a trigger operation on the construction task control in the task order creation interface, displaying a task tree interface;
in response to determining that the user performs a trigger operation on one or more task nodes in the task tree interface, determining one or more specified task items; and
determining the one or more candidate task entries based on the one or more specified task items.

5. The method of claim 4, wherein the determining the one or more candidate task entries based on the one or more specified task items includes:
taking a task combination before the trigger operation on the construction task control as a reference task combination;
determining one or more candidate task pairs from a plurality of preceding-subsequent task pairs included in a task pair set; wherein each preceding-subsequent task pair includes a preceding task combination, a subsequent task combination, and a probability value, and a candidate task pair is a preceding-subsequent task pair whose preceding task combination is the same as the reference task combination;
taking construction task entries including the one or more specified task items from the task entry set as a first subset;
taking construction task entries including subsequent task combinations of the one or more candidate task pairs from the task entry set as a second subset; and
determining an intersection of the first subset and the second subset, and in response to determining that the intersection is non-empty, taking one or more construction task entries in the intersection as the one or more candidate task entries.

6. The method of claim 5, further comprising:
in response to determining that the intersection is empty, determining one or more target arrays including the one or more specified task items from an array set, and sorting the one or more target arrays in descending order of occurrence frequency; wherein the array set includes one or more arrays, each array including a low-weight task item and an occurrence frequency of the low-weight task item;
removing a specified task item corresponding to a target array with a highest occurrence frequency in the one or more target arrays; and
re-determining the intersection of the first subset and the second subset based on remaining specified task items until the intersection is non-empty.

7. The method of claim 2, wherein each of the one or more candidate task entries further includes a plurality of representative costs and probability values corresponding to the plurality of representative costs; and the method further comprises:
in response to determining that the user performs a selection operation on a representative cost of the selected candidate task entry, determining at least one of a pricing manner or a measurement unit price for the construction task order based on the selected representative cost.

8. The method of claim 4, wherein each of the one or more candidate task entries further includes a plurality of representative costs and probability values corresponding to the plurality of representative costs; and the method further comprises:
in response to determining that the user performs a selection operation on a representative cost of the selected candidate task entry, determining at least one of a pricing manner or a measurement unit price for the construction task order based on the selected representative cost.

9. The method of claim 1, wherein the graphical user interface includes a contract information interface, and the preset control includes a dispatch control;
wherein the in response to determining that a user performs a trigger operation on a preset control in the graphical user interface, reading one or more candidate task entries from a task entry set pre-stored in the memory by a processor includes:
in response to determining that the user performs a trigger operation on the dispatch control in the contract information interface, reading the one or more candidate task entries from the task entry set pre-stored in the memory by the processor.

10. The method of claim 9, wherein each of the one or more candidate task entries corresponds to a create-task-order control; wherein the in response to determining that the user performs a selection operation on the one or more candidate task entries displayed in the graphical user interface, writing a task combination corresponding to a selected candidate task entry into a construction task order by the processor to determine a construction task further includes:
in response to determining that the user performs a trigger operation on the create-task-order control corresponding to a candidate task entry, determining the selected candidate task entry, displaying a task order creation interface corresponding to the selected candidate task entry, and writing the task combination corresponding to the selected candidate task entry into the construction task order to determine the construction task.

11. The method of claim 10, wherein the candidate task entries further include a plurality of representative costs and probability values corresponding to the plurality of representative costs;
and the method further comprises:
in response to determining that the user performs the trigger operation on the create-task-order control, determining at least one of a pricing manner or a measurement unit price for the construction task order based on a representative cost of the candidate task entry corresponding to the create-task-order control.

12. The method of claim 1, further comprising:
obtaining the task entry set; wherein the task entry set includes a plurality of construction task entries, and the candidate task entries belong to the task entry set.

13. The method of claim 12, wherein the obtaining the task entry set includes:
generating a plurality of pieces of first entry data based on the plurality of pieces of historical task data, and dividing the plurality of pieces of first entry data into one or more first entry sets according to a first grouping characteristic; wherein the first grouping characteristic includes a unit type, and each piece of first entry data includes a historical task combination, cost data, and a frequency;
for each first entry set: dividing a plurality of pieces of first entry data in the first entry set into a plurality of second groups according to a second grouping characteristic, and generating a plurality of pieces of second entry data based on the plurality of second groups, respectively;
constructing a second entry set based on the plurality of pieces of second entry data from each first entry set; wherein the second grouping characteristic includes the historical task combination, a pricing manner, a measurement unit, and the cost data, and each piece of second entry data includes the historical task combination, a representative cost, and a representative frequency; and
dividing a plurality of pieces of second entry data in the second entry set into a plurality of third groups according to a third grouping characteristic, and generating a plurality of construction task entries based on the plurality of third groups, respectively, to construct the task entry set; wherein the third grouping characteristic includes the historical task combination, and each construction task entry includes the historical task combination, a plurality of representative costs, and a representative frequency and a probability value corresponding to each representative cost respectively.

14. The method of claim 13, further comprising:
for each piece of first entry data, adjusting the frequency of the piece of first entry data based on a historical creation time corresponding to the piece of the first entry data.

15. The method of claim 14, wherein the adjusting the frequency of the piece of first entry data based on a historical creation time corresponding to the piece of first entry data includes:
in response to determining that a difference between the historical creation time corresponding to the piece of first entry data and a current time is within a preset time range, increasing the frequency of the piece of first entry data by a preset adjustment amount; and
in response to determining that the difference between the historical creation time corresponding to the piece of first entry data and the current time exceeds the preset time range, decreasing the frequency of the piece of first entry data by the preset adjustment amount;
wherein the preset adjustment amount is positively correlated with the difference.

16. The method of claim 13, wherein the dividing a plurality of pieces of first entry data in the first entry set into a plurality of second groups according to a second grouping characteristic, and generating a plurality of pieces of second entry data based on the plurality of second groups respectively includes:
dividing the plurality of pieces of first entry data in the first entry set into a plurality of fourth groups according to a fourth grouping characteristic; wherein the fourth grouping characteristic includes the historical task combination, the pricing manner, and the measurement unit;
for each fourth group: sorting a plurality of pieces of first entry data in the fourth group according to the cost data; and
obtaining the plurality of second groups by grouping the sorted plurality of pieces of first entry data in each fourth group based on a cost tolerance range;
obtaining corresponding second entry data based on each second group, including:
for each second group:
determining historical task combinations of a plurality of pieces of first entry data in the second group as a historical task combination of the second entry data corresponding to the second group;
performing a weighted average calculation on the cost data of the plurality of pieces of first entry data using frequencies of the plurality of pieces of first entry data in the second group as weights, and determining a result of the weighted average calculation as a representative cost of the second entry data corresponding to the second group; and
determining a sum of the frequencies of the plurality of pieces of first entry data in the second group as a representative frequency of the second entry data corresponding to the second group.

17. The method of claim 13, wherein the generating a plurality of construction task entries based on the plurality of third groups respectively includes:
for each third group,
determining a sum of representative frequencies of a plurality of pieces of second entry data within the third group;
determining a probability value corresponding to each representative cost based on the representative frequency of each piece of second entry data and the sum of representative frequencies, respectively; and
obtaining the construction task entry based on the historical task combinations, the plurality of representative costs, and the representative frequency and probability value corresponding to each representative cost of the plurality of pieces of second entry data within the third group.

18. The method of claim 13, further comprising:
for each piece of first entry data, determining a piece of adjacent entry data of the piece of first entry data based on a historical creation time corresponding to the piece of first entry data;
constructing an initial preceding-subsequent task pair based on the historical task combination of the piece of first entry data and a historical task combination of the piece of adjacent entry data of the piece of first entry data, and determining a frequency for the initial preceding-subsequent task pair based on frequencies of historical task combinations in the initial preceding-subsequent task pair;
merging identical initial preceding-subsequent task pairs from a plurality of initial preceding-subsequent task pairs to obtain a plurality of preceding-subsequent task pairs, and determining a sum of frequencies of the identical initial preceding-subsequent task pairs to determine a frequency for a corresponding preceding-subsequent task pair; wherein preceding-subsequent task pair includes a preceding task combination, a subsequent task combination, and a frequency;
dividing preceding-subsequent task pairs having an identical preceding task combination into a same task pair group; and
for each task pair group: determining a total frequency of a plurality of preceding-subsequent task pairs within the task pair group, and determining a probability value for each preceding-subsequent task pair based on the total frequency and a frequency of each preceding-subsequent task pair within the task pair group.

19. The method of claim 13, further comprising:
determining similar task pairs based on the task entry set; wherein each similar task pair includes two construction task entries satisfying a preset condition, the preset condition including that a count of differing task items between the two construction task entries does not exceed a preset count threshold, and probability values corresponding to representative costs, whose cost difference between the two construction task entries falls within a cost difference range, are all not lower than a probability threshold;
obtaining, for each similar task pair, a differing task item and a frequency of the similar task pair to construct a plurality of initial arrays; each initial array includes the differing task item and the frequency of the similar task pair;
merging initial arrays with an identical differing task item to obtain a corresponding array, taking the identical differing task item as a low-weight task item for the corresponding array, and determining a sum of frequencies of the initial arrays with the identical differing task item as an occurrence frequency corresponding to the low-weight task item of the corresponding array; and
obtaining an array set based on one or more arrays.

20. A method for obtaining a task entry set, comprising:
generating a plurality of pieces of first entry data based on a plurality of pieces of historical task data, and dividing the plurality of pieces of first entry data into one or more first entry sets according to a first grouping characteristic; wherein the first grouping characteristic includes a unit type, and each piece of first entry data includes a historical task combination, cost data, and a frequency;
for each first entry set: dividing a plurality of pieces of first entry data in the first entry set into a plurality of second groups according to a second grouping characteristic, and generating a plurality of pieces of second entry data based on the plurality of second groups, respectively;
constructing a second entry set based on the plurality of pieces of second entry data from each first entry set; wherein the second grouping characteristic includes the historical task combination, a pricing manner, a measurement unit, and the cost data, and each piece of second entry data includes the historical task combination, a representative cost, and a representative frequency; and
dividing a plurality of pieces of second entry data in the second entry set into a plurality of third groups according to a third grouping characteristic, and generating a plurality of construction task entries based on the plurality of third groups, respectively, to construct the task entry set; wherein the third grouping characteristic includes the historical task combination, and each construction task entry includes the historical task combination, a plurality of representative costs, and a representative frequency and a probability value corresponding to each representative cost respectively.
